(19) United States
(12) Patent Application Publication
(10) Pub. No.: US 2018/0347156 A1
(43) Pub. Date: Dec. 6, 2018

(54) Watervaporextractor

(71) Applicant: Herman E. Lessey, Benson, NC (US)

(72) Inventor: Herman E. Lessey, Benson, NC (US)

(21) Appl. No.: 15/612,592

(22) Filed: Jun. 2, 2017

(51) Int. Cl. E03B 3/28; C02F 1/22

(52) U.S. Cl. CPC E03B 3/28; B01D 5/006; C02F 1/22

(57) ABSTRACT

The High Thermal Frost and Crystal Growing Water Maker, is a fully automated, fixed or mobile water making appliance designed to grow frost and crystal at an accelerated rate within its high thermal water crystals growing chamber. At the end of the crystals optimal freezer growth stage in the chamber, the fully-grown crystals and frost spicules, are melted within its harvesting apparatus. The then melted frost and crystals which is now converted to a liquid water, is afterward filtered using a variable stage filtration system within the unit. The crystal growing and water harvesting appliance is design to cycle continually; and at the end of any of the growth, harvesting and filtration cycle, the melted and filtered crystal liquid H2O, is siphon from the unit, to be use as potable water for any purpose.

### BACKGROUND OF THE INVENTION

This invention relates generally to a deep freezer compartment system, but more principally directed to a freezer chamber of this category that uses; evaporator coils, defrost systems, compressor motor systems, evaporator fans, heater system control, warm humid air and nozzle circulation intake system within the walls of the chamber for increasing the moisture in the enclosed chamber space. And having a control air nozzle circulation intake system; where air is cooled by an evaporator, and circulated evenly within the thermal emissivity freezer chamber. And where warm force air is then combine with low temperature and a warm air vapor splashing technique to form and accelerate the growth of frost and water crystal on the surfaces, its multiple high thermal emissivity crystal starter plates and walls within the chamber. And by combining a control method of sublimation and deposition, warm air vapor is transformed into frost and crystal. The process of controlling the growth rate of the water crystal within the chamber; is achieve by regulating the warm air flow and the amount of moisture in the chamber. And by varying the temperature within the freezer between −32 degrees F. and −o5 degrees F., the optimal desired control of the fusion growth rate of the frost and crystal is sustained. One's the desired growth rate of the crystals is reach on the surface of the multiple high emissivity thermal plates and freezer walls; the fusion process of melting the crystals is activated; using heater coils or optional hot gasses to change the fully matured frost and crystals, back to a liquid water state H2O. Further, while the frost and ice crystals is going through the melting process, the melted crystal water is simultaneously siphon from the freezer chamber reservoirs, to the main drain outlet basin, were the harvested water is stored and later filtered; for the delivery of clean and healthy water. More importantly, this invention relates to a new method, or an apparatus designed specifically for growing in a regulated and manage way; the formation and growth of frost and crystals on the surfaces of its internal high emissivity thermal plates and chamber walls. When warm humid air from an external source is channel into the interior of the freezer chamber; and we factor in the effects that a drastic change between the ambient air temperature and the interior temperature of the freezer; the warm moisture present in the air funneled from outside atmosphere, quickly cools condenses into vapor or fog. Then owing to the regulation of the warm air, and the temperature within the chamber, the air vapors/fog slowly deposit himself on the surfaces of the multiple high emissivity thermal plates in the chamber; subsequently, forming frost and ice crystals. This process is known as deposition, sublimation, vaporization and fusion. Then by managing the sublimation processes, the growth rate of ice crystals and frost in the chamber is accelerated; resulting in the mass growth of ice crystal and frost on the frost growing interior high thermal emissivity plates and walls. And at the optimum growth time, the fully-grown water crystals are melted, then harvested as pure drinking water, (H2O.)

This scientific method of managing the DE-sublimation process, is the key to understanding how the High Thermal Freezer, transforms water vapors (gas) from the atmosphere; into growing crystalline frost. And when the crystals reach their optimal growth level, they are then melted to form liquid water, H2O. Ice automatically forms when any surface is chilled below the dew point of the air surrounding it, and that surface is below the freezing point. But for DE-sublimation to transform into crystals; the air must be humid enough, but not so humid that it causes the formation of water or ice; instead of crystal. To regulate the crystal growing process; the temperature and the amount of water vapor available in the surrounding air is optimally sustained, to maximize the crystal growth rate and the subsequent harvest of its water. Further, to accelerate the growing process of the frost, and increase the size of the crystals on the surface of the high thermal emissivity plates; a technique call vapor splashing and warm air injection into the chamber is use. Vapor splashing is a method of artificially injecting warm vapor into the freezer chamber, at the initial crystal spicules growing stage or simultaneously during the growing process of the crystals. Further, to facilitate the rapid growth of the water crystals; a specialized high thermal emissivity surfaces on all the inner freezer surfaces is used for starting and growing the crystals, such as: blackened metal surfaces and the like. The entire fusion DE-sublimation and Deposition process of going from warm atmospheric air vapor to crystalline spicules to drinking water takes place within the boundaries of the freezer chamber, using the following freezer related equipment's, components and process: air duck's intakes, a discharge means, low level circulating warm vapor fan, exhaust vent, frost growing plates, defrost heater coils, flash freeze technique, wall to wall evaporators, supporting freezer equipment and an access entry to the chamber interior. A further object of this invention is to provide a new method for the deposition, sublimation and harvesting of clean and safe water for drinking, agriculture or any other social needs. It's a scientific fact, that virtually all of world fresh water is stored in the atmosphere as vapor and moisture. And through the process of evaporation, condensation and precipitation; nature provides humanity with water through rain, rivers, glaziers, lakes and the like. And although three quarters of the earth surface is covered with water, only 2.5% of this water is fresh and consumable. Besides, owing to the increase population growth; the world bank stated that by the year 2025 more than 2.8 billion people will struggle with access to clean drinking water. Today it's over 1.6 billion. The high level of pollution in our rivers and lakes, and the long-term effects of drought due to un-explained climate conditions; lack of controlled of our protected wetland resources; the high cost of processing drinking water and the very expensive cost desalinating ocean water, has created a global water crisis, scarcity and ready access to clean water for the world population. Water is the most precious commodity on our planet, “water is life” and this invention will bridge the gap, and help make potable water easily available to all humanity.

### SUMMARY OF THE INVENTION

The principal object of this invention is to have a deep freezer frost generating system that comprises of single; or, multiple freezer compartment module in grouping. Its main purpose is to grow and harvest water crystals to produce fresh drinking water; using a sublimation and deposition technique to grow and cultivate crystals there within. Then after the crystal growing process is complete, the system systematically melts the full-grown crystals into a liquid state H2O; from which a safe, clean and a renewable source potable water is harvested. The invention simply extracts the trap water vapors from the surrounding atmosphere using deposition and sublimation to grow crystals from the warm air vapor. This new water harvesting technological process will provide humanity with a ready alternative source of safe and sustainable water (H2O) for drinking. All of Its main freezer components and water making process are designed to be powered by any renewable source of energy such as the (SUN). Or, an alternate source such as a grid powered system. The use of solar energy as its main power source makes this new technology 100% green, renewable and environmentally friendly. Another main object of the present invention is to provide an improve freezer apparatus in an enclosed dome housing or any plurality shape that includes all its supportive equipment, instrument and controls. The principal objective of this new invention are the following: all conventional industrial or domestic freezer systems are designed to stop frost; or, to defrost ice crystal or, to prevent frost or ice from growing or accumulating in either the freezer chamber compartment or the main food storage cabinet. Then, defrost and dispose or evaporate the remaining melted ice residue if any. Many known patented inventions do this very well and many patents have been issued that solves the vexing problem of eliminating frost from growing in a refrigerator or freezer compartment using countless different defrosting techniques and or evaporation methods. However, it's a feature of the present invention to deviate completely from all such previous invention and technology. The present invention is a deep freezer system that is 100% different or opposite in purpose and function; from all other freezer defrosting patented apparatus in use today. The high thermal water crystal freezer growing machine; was designed for a completely different mission and goal. The principal objective of this new technology is 100% opposite to all the above freezer inventions either patented or on the market today. “The main goal, purpose, and objective of this freezer crystal water replicating apparatus; “IS TO GROW THE LARGEST QUANTITY OF WATER CRYSTALS IN THE SHORTEST POSSIBLE TIME WITHIN THE FREEZER CHAMBER; AND WHEN MATURELY GROWN CRYSTAL REACH THEIR OPTIMUM HARVESTING STATE, THE SYSTEM AUTOMATICALLY MELTS THE CRYSTALS BACK TO H20, THEN HARVESTED FOR THE USE AS AN ALTERNATIVE SOURCE OF CLEAN WATER.”, When the water crystals reach their full growing state of maturity, an internal heater melting process is activated to defrost the fully grown crystals back to a liquid state, where it's subsequently filtered and process to be used as “CLEAN AND SAFE POTABLE WATER”; (H2O), this water can be consumed before or after the internal filtration process is complete. This organic and 100% renewable frost growing and harvesting cycle is repeated ad-infinitum for the sole purpose of producing and harvesting an alternative source of clean water. Further objects and advantages of this invention will become apparent herein. these and other objects and fuller understanding of the invention describe and claimed in the present application will be seen following the description and claimed taken in conjunction with the accompanying drawings. Numerous freezer frost system utilizing condensers have been invented and adapted for use in eliminating frost from a freezer, or as part of a dehumidifiers that captures warm air and condenses it into water; if, the humidity is above 40% the altitude is below 4000 feet and the ambient air temperature is above 35 D.F. But unlike those water making dehumidifier with low pH's level water on the market today; and all their atmospherics and weather limitations.

None, have been designed or invented to used vapor from the Atmospheres, Vaporization, Condensation, Sublimation, Fusion, vapor splashing, crystal promoter, and or a pH level duplicating technique, complete with its own natural filtration system, re-mineralization technology, and water restructure technology, to duplicates nature and the natural state of spring water, by using this scientific technique of harvesting water from crystals for the sole and explicit purpose of producing clean and fresh potable water for humanity. Additionally, this system is 100% green, and was specifically designed to be powered with any renewable energy technology. For example: U.S. Pat. No. 3,793,847 Scarlett. EP Pat. 2013555 A2 Powers and Crump. U.S. Pat. No. 3,403,533 Bollenbacher. EP Pat. 1510768 A1 Elliot. U.S. Pat. No. 3,370,439 Rivard. U.S. Pat. No. 3,522,712 Carl. U.S. Pat. No. 2,331,560 Mamsealer. U.S. Pat. No. 2,960,844 Quick. While these units may be suitable for the purpose to which they address; they would not be suitable for the purpose of the present invention. For further objects and advantages of this inventions, see the following descriptions and the claims annexed to, and forming a part of the specification.

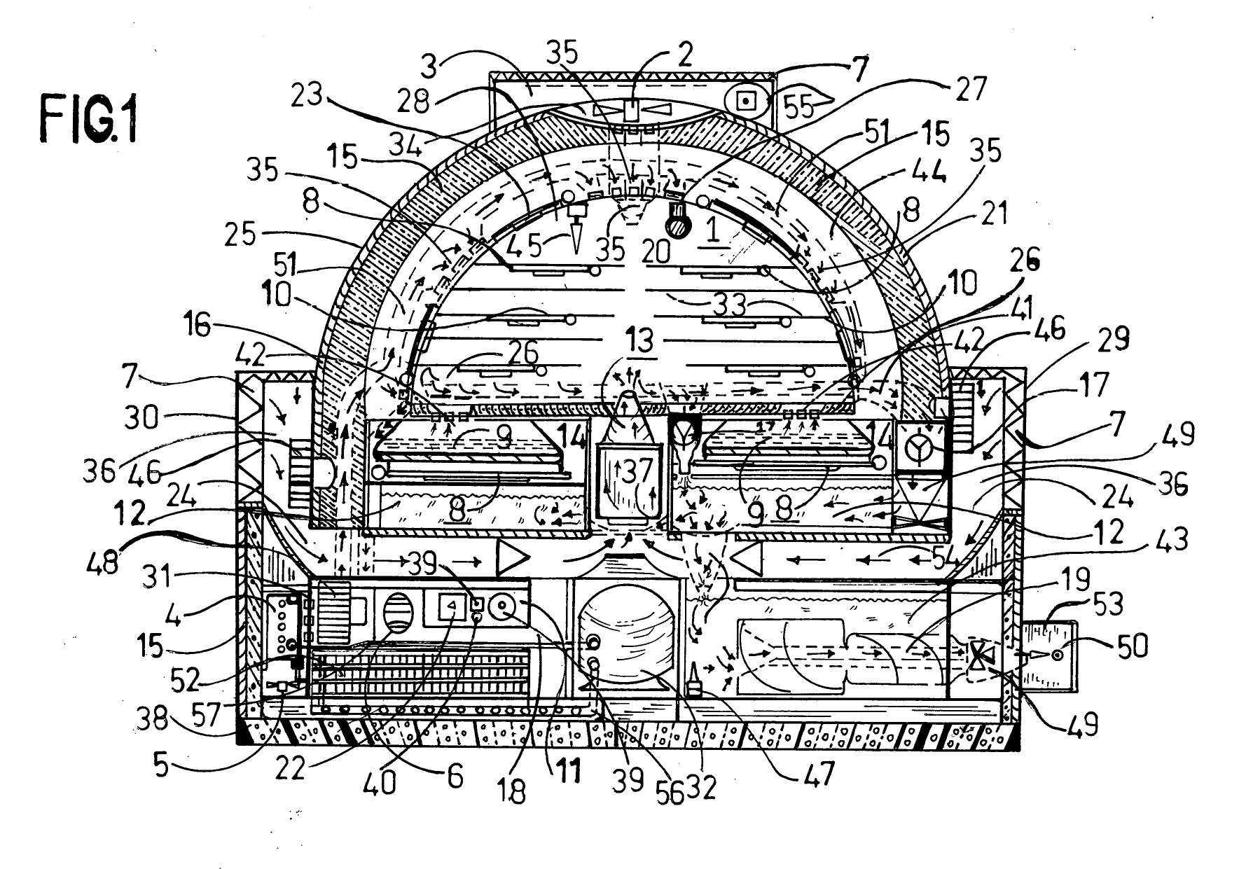

Referring now to the drawings of FIG. 1, a high thermal emissivity fast freeze, pH replicator, natural filtration system and rapid crystal growing freezer chamber apparatus 1, a high impact centrifugal evaporator circulator fan that keeps low level air vapor and refrigerated air circulating evenly throughout the freezer 48, and exhaust vent that help maintain or manage the air temperature and warm vapor within the freezer chamber 3, evaporator coils use to absorb heat from inside the freezer by means of the cooled refrigerant inside its coiled 4, condenser fans to help cool the refrigerant in the coils 5, optional defrosting hot gas coil system and grill cover 6, a high particulate air vapor filtering system 7, a defrost heater coil array 8, pH spring water catalyst reservoir housing and heater coils 9, angle perforated high thermal emissivity pH frost replicating growing plates and deposition surface 10, freezer equipment compartment control unit and housingl, melted liquid water reservoir drain outlet basin and housing 12, warm air venturi vapor intake injection nozzle circulation system and housing 13, pH vapor splashing crystal promoter frost basin pan system and housing 14, a freezer wall heat exchange barrier between the inner and outer wall built of any plurality of materials 15, entry-exit removable inner access freezer dome component 16 main water drain pump system and housing 17, compressor coils, compressor relay, freezer temperature control unit, defrost limit switch, thermostat setting, drain control, on and off switches, circulation fan control, air nozzle control, defrost timer, freezer timer system and flash freeze timer, primary freezer condenser/compressor housing unit with control panels 18, vortex water filtration system and housing 19, blackened stainless steel interior made of any plurality freezer element material 20, exterior wall systems made of any plurality of similar freezer exterior element materials 21, fast freeze freezer frost replicating procedure, rapid crystal defrosting system and a frost growing timer panels 22, defrost heater coils that melts all the crystals that grows in the chamber 23, air vapor air duck circulation conduit 24, dome shape freezer structure or any other plurality of shape 25, main water discharge drain tube and housing 26, inner dome light system 27, blackened inner freezer wall deposition surface 28, air vapor entry ducks 29 and 30, evaporator cover 31, compressor motor and non toxic, environmentally safe, 100% organic refrigerant and housing unit 32, complete blackened inner chamber interior and deposition surfaces 33. fan and exhaust vent and housing 34, evaporator cold air vents 35, filter system housing 36, air and warm air injector nozzle housing 37, support foundation 38, cycle timer and frequency defrost duration control 39, defrost limit switch turns off the defrost heater coils when the crystals in the chamber is melted 40, insulated freezer foundation and inner and outer wall barrier 41, vapor splashing freezer vents 42, melted water chamber collecting means reservoir 43, detachable dome shape freezer housing 44,

Thermostat apparatus 45, an air vapor inlet circulating centrifugal blower means 46, a water level thermostat apparatus means 47, centrifugal cold air circulating means and housing 48, water valve means 49 water discharge valve means 50, cold air supply duct means 51, a static condenser means 52, water discharge valve housing means 53 air flow arrow 54 auxiliary motor means 55, compressor refrigerant discharge line 56, condenser to evaporator suction return line 57.

The freezer apparatus of this invention functions in a conventional manner as other commercial deep freezer, that produces and funnel cold refrigerated air to a chamber. The subzero degree temperature in the freezer chamber of this high thermal emissivity fast freeze, pH replicator and rapid crystal growing freezer chamber; is affected by the flow of refrigerated air there through by a suitable amount of cold air moving means such as a centrifugal blower; up and through, and extending the flow of cold air through the supply duct and into the freezer chamber as shown in FIG. 1 The motor compressor 32, is connected via a compressor refrigerant discharge line 56, to the condenser 52, while supply restriction line 4, connects the outlet of the condenser to the evaporator and suction return line that connects the evaporator to the compressor inlet 57.

The optimum temperature in the freezer chamber is maintained by the flow of refrigerated cold air throw-out the chamber cavity, by a suitable quantity air moving means, such as the centrifugal blower as shown in FIG. 1, Item 2, and the cold air vents item 35's; a completed air vapor flow distribution cycle for the high thermal freezer replicator chamber; wherein the fan 48, delivers about 45 cfm of cold air flow within the freezer chamber 1, that's distributed through the evaporator cold air vents, 35, with 95 percent of the cold air flowing on through and around the high thermal emissivity crystal growing plate 10, and the interior walls 20, it should be noted that prior to turning on the freezer system, the spring water catalyst 9, is prime with spring water of the appropriate PH level. The catalyst water is used as a crystal starter to grow the first ice spicules of which the water crystals will grow. The catalyst heater coils 14, is used to raise the temperature in the spring water reservoir to above 212 degrees F., converting this water into a gas vapor within the chamber. One's the freezer reach its optimum freezing point, warm air vapor is injected into the chamber, this vapor is then funnel from the air filter housing 29, containing the filter system, the vapor then passes through the air vapor duck 24, to the warm air injection nozzle mechanism 37, the warm air injection nozzle 13, warms up the air to the desired temperature, before injecting it into the chamber, this warm air injection process facilitates the rapid growth of water crystals on the high thermal growing plates. All excess air or pressure in the chamber is discharge to the atmosphere via the exhaust vent 3, and as the chamber temperature fluctuate between −5 and −30 degree F., water crystal and frost begin to form and grow, on the growing plates 10, the process of enabling ice crystal growth by using water splashing, warm air injection and air circulation within the high emissivity freezer chamber continues during the crystal growing stage, until the crystals reaches their optimum growth and harvesting phase. At this stage the freezer is automatically or manually turn of and the melting cycle and the harvesting of the defrosted water begins. Once the freezer is turn off, the defrost heater coils 10, located throughout the freezer is activated to facilitate and accelerate the rapid melting of the ice crystal into potable water H2O. This is call the water harvesting cycle. During this melting process, the defrosted water is collected into the melted water crystal reservoir 26, and is then pump into the melted liquid water reservoir drain outlet basin and housing 12, by means of the main water drain pump system 17, this harvested water is then fed into a vortex filtration system 19, before been discharge through the main water discharge drain tube 50, for distribution.

The water crystal freezer chamber includes a freezer control circuit system; that manage the evaporator, condenser, heater system, warm air injection nozzle apparatus, air circulating fan, and a water drain system arrange to operate for the sole purpose of growing ice crystals; then melting said crystal for the harvesting of drinking water. The temperature sensor system is program to monitor the operating temperature of the freezer; control the duration of the crystal growing process, then melt said ice crystal at their optimum growing harvesting period. This control means, times and manage the draining and extraction of the melted water from its reservoir during and after the melting process. The system control and analyses the evaporator temperature, during the growing process and determines the optimum time of when to begin the defrosting phase. This main control reads and monitor the chamber temperature, the on-off cycle of the freezer, and the duration of the crystal growing process, then determines the optimum time to activate the defrost eater coils that melts the fully-grown crystals. The main circuit panel includes a freezer temperature sensor control, warm air nozzle cycle control, defrost cycle timer, main on/off freezer switch, circulating fan control switch, drain pump adjustment control, spring water catalyst sensor controls, defrost heater coil on-off switch, exhaust vent switch, internal light switch, the monitor of all drain water reservoir level and all sensors in the freezer chamber. A further object of this invention is to provide a unit that is dome shape or of any other plurality of shapes; and can be built below or above ground; with a capacity to operate in any weather environment. It includes models designed principally for home usage, corporations, industrial applications, farming, or, as an alternative water supply system for any city, state or a country. The units are constructed to be portable or of a permanent structure; and can be constructed in any plurality of size's and freezer capacity according to the needs and water demand. All the units regardless of size, are designed to be powered by either a direct connection to the local grid, or by any array of solar panel electrical system. Solar panels are the indorsed and preferred method to power any of the cold fusion water replicating plants. A further object of this invention is to provide a mechanism and a new technology that will help reduce the accumulated water moisture built up in the global atmosphere; this is done by extracting the moisture and converting it to clean drinking water. According to most atmospheric experts, there are 6% more moisture in the global atmosphere today than before, cause by irregular weather conditions; which triggers extreme rain in some areas of the world and massive drought in others. This technology will help to reduce this irregular global atmospheric climate condition worldwide, by converting this excess atmospheric moisture into fresh clean drinking water.

FIG. 1 Schematic view of the structure of the present invention.

While the embodiment of the present invention as herein disclosed only constitute a preferred form; it should be understood that other designed may be adopted.

1. A high thermal frost and crystal growing water maker, having a control air nozzle circulation intake system; were said air is cooled by an evaporator, and circulated evenly within the thermal emissivity freezer chamber; and where a funnel intake air system is combine with low temperature and a warm air vapor splashing technique to form and grow large frost and water crystal at an accelerated rate on the surfaces of the high thermal emissivity crystal starter plates and walls within the insulated freezer chamber; and where said grown crystal and frost at their optimal growth stage, are melted and harvested for potable water H2O.

2. I claim a high thermal freezer chamber appliance according to claim 1, in which a high impact centrifugal evaporator circulator fan mechanism and means for providing low level air vapor and refrigerated air, circulating evenly throughout the freezer for the acceleration of the growing of water crystal; and having an exhaust vent mechanism and means use to help maintain and manage the air temperature and water vapor within the freezer chamber; in which evaporator coils mechanism are used to absorb heat from inside the freezer chamber by means of the cooled refrigerant inside its coiled; plus, a condenser fan mechanism use to help cool the refrigerant in its coils for the sole purpose of the growing of crystal in the freezer, and having a hot gas coiled mechanism and means use to supplement and accelerate the defrosting and melting of grown water crystal on the surface of the thermal plates and walls of the freezer chamber.

3. I claim a high thermal freezer chamber appliance according to claim 2, in which a high particulate air filter system mechanism in the filter housing; is use to filter the air vapor entering the chamber apparatus from the atmosphere. And having a defrost heater coil array mechanism means in the chamber, use to melt the growing, or fully-grown ice crystal within the chamber apparatus; and having a pH spring water catalyst reservoir mechanism, and means in its housing and heater coils used as a crystal starter and pH catalyst replicator during the first phase of growing the water crystals for use as potable water. And having a blackened like perforated high thermal emissivity pH frost replicating growing plates and deposition surface mechanism in the chamber for the accelerated growth of the crystals and frost.

4. I claim a high a high thermal freezer chamber appliance according in which a freezer equipment compartment mechanism and means; its housing and control panel unit and frost liquid water reservoir, is used to collect and store the melted water crystals; and the drain outlet basin and housing for draining the treated and harvested water. And having a warm air vapor injection nozzle circulating system and means, its housing unit injects warm vapor into the freezer chamber to help accelerate the formation and growth rate of water crystal on the growing plates and freezer surfaces; for the purpose of the accelerated growth of the water crystals. And having a pH warm air vapor crystal splashing promoter frost basin system and housing, for use during the initial phase of the crystal growing stage, to accelerate and promote the desired pH level in the water crystals. And having a freezer walls heat exchange barrier between the inner and outer wall, built of any plurality of freezer wall insulating materials; use to maintained the optical required temperature within the chamber for maintaining the optimal temperature within the chamber during the crystal growing process.

5. I claim a high thermal freezer chamber appliance according to claim 4, in which a circuit system, evaporators, condenser, compressor coils, compressor relay, freezer temperature control unit, defrost limit switch, thermostat setting system, drain control, on and off switches, circulation fan regulator, air nozzle regulator, defrost, freezer and flash freeze timer regulators, freezer condenser and compressor system control panel all arrange to monitor and manage the growing cycle of the water crystals, for the purpose of growing crystal for the use as water. And having a control means that monitors the evaporators freezer temperature and timer to determines when to turn the freezer cycle on and off and at which time each defrost period begins or ends. It takes into account the data provided by evaporator temperature sensor prior to beginning the defrost cycle; the control means manages the entire cycle of the freezer chamber operation. And having high thermal freezer chamber according to claim 1, in which the chamber interior wall, its surfaces, and the crystal growing plates is made of any plurality of blackened metal material, or any other plurality of similar freezer chamber surface and material, to be used for the sole purpose of growing crystals for potable water. And having a fast freeze method, freezer frost pH replicating technique, a rapid crystal defrosting system, a water crystal frost growing and defrosting timer, for the growing of crystals in which an array of defrost eater coils within the freezer chamber and on the surface of the crystal growing plates, is used to melt the water crystals at any stage of growth for the purpose of harvesting water. And having eater coils use to raise the temperature within the chamber to above 32 degrees F. in which an air duck circulating conduit system is use to funnel warm air vapor from the high particulate air filter system into the freezer chamber, to assist in the growing of water crystal. And a discharge means through the main drain tube from the water reservoir for final discharge and storage of water.

6. I claim a high thermal freezer chamber appliance according to claim 1, in which multiple air vapor entry ducks and covers, are used to manage and channel warm air from the atmosphere into the air vapor and air duct circulation conduit, air is then funnel through the air duck circulation conduit to the warm air vapor injection nozzle and housing and into the freezer chamber; for the purpose of accelerating the growth rate of water crystals. And having a compressor motor using a non-toxic and environmentally safe 100% organic refrigerant to pump said refrigerant through a sealed coiling system; in the freezer mechanism, for the purpose of growing the water crystal. And in which a fan couple with an exhaust vent and housing is use to manage the air vapor in the freezer chamber that assist in the growing process of crystal. And having a series of evaporator cold air vents on the freezer chamber inner walls used to channel freezing air into the freezer interior for managing the growth rate of the crystal. And having a cycle timer that controls the frequency and duration of growing the water crystal; and a defrost limit switch that turns off the defrost heater coils, when all the crystals in the chamber is melted; And were a vapor splashing technique is used to accelerate the growth rate of the initial growing phase of the water crystal.

7. I claim a high thermal freezer chamber appliance according to claim 1, in which a water reservoir mechanism at the bottom of said freezer chamber, is use to filter, re-mineralize and restructure the collected melted crystal water for storage and distribution.

8. I claim a high thermal freezer chamber appliance according to claim 1, in which a freezer mechanism is used to extract and reduce the accumulated water moisture built up in the global atmosphere by extracting said moisture and converting it to water, H2O. Said freezer cabinet having an insulated dome shape or any plurality of chamber form body; such mechanism and means extend from the bottom of the evaporator circulation fan and exhaust vent, in a circumference profile down to the base of the freezer equipment housing and water reservoir foundation.
